(19) United States
(12) Patent Application Publication
(10) Pub. No.: US 2015/0246420 A1
(43) Pub. Date: Sep. 3, 2015

(54) ALIGNMENT PIN

(71) Applicant: Caterpillar Inc., Peoria, IL (US)

(72) Inventors: Andrew M. Denis, Peoria, IL (US); Raymond U. Isada, Peoria, IL (US); Lucas J. Greene, Peoria, IL (US)

(73) Assignee: Caterpillar Inc., Peoria, IL (US)

(21) Appl. No.: 14/700,214

(22) Filed: Apr. 30, 2015

(51) Int. Cl. B23P 19/04

(52) U.S. Cl. CPC B23P 19/04

(57) ABSTRACT

An alignment pin attachable to a first member for piloted engagement with an aperture defining a circular edge portion within a second member is provided. The alignment pin includes a curved tip portion. A piloting section includes a conical locating portion extending circumferentially from the curved tip portion. A cylindrical locating portion extending from the conical locating portion defines a first height and a first diameter. An engagement portion extending from the cylindrical locating portion defines a second height and a second diameter. The engagement portion of the alignment pin is structured and arranged to engage within a receiving hole in the first member. The second member is coupled with the first member through piloted engagement between the circular edge portion of the second member and the sequential piloted engagement with the conical locating portion and the cylindrical locating portion of the alignment pin.

### TECHNICAL FIELD

The present disclosure relates to an alignment pin, and more particularly to the alignment pin for assisting in positioning and coupling of heavy components.

### BACKGROUND

Installation and assembly of heavy machinery components, for example, an exhaust gas aftertreatment system, includes positioning of multiple components with respect to each other. The components, for example, an emission module to be placed on a frame, are heavy and require substantial skill for accurate and precise positioning. The frame includes one or two pins corresponding to receiving portions on the emission module. The pins assist in coupling of the emission module over the frame.

Some of the pins include sharp pointed edges to constrain movement of the mating components. The pins also include sharp pointed tips to assist locating among the mating components. The sharp pointed edges and tips of such pins may however cause damage to areas surrounding the receiving portions. Further, some of the pins are cylindrical in shape. However, such pins may not assist in quick and easy locating of the mating components, specifically in situations in which the components are lowered by a crane. Additionally, known pins are generally difficult to install and have high installation costs associated therewith. Further, the installation time is high and locator accuracy may also be lower than required. Such pins are not universal and generally have limited application.

U.S. Pat. No. 6,321,814, hereinafter referred to as the '814 patent, relates to a labeler for the placement of self-adhesive labels onto compact disks, having a positioning cone with a cylindrical extension, a flat surface with a diameter greater than that of the cylindrical extension, and a tapered end opposite the cylindrical extension, a positioning plate having a central positioning hole, and a surface upon which a self-adhesive label can be placed, and a base supporting the positioning plate, having a hollow space below the positioning plate. However, the '814 patent does not describe the pin utilized for alignment and positioning for heavily weighed components.

### SUMMARY OF THE DISCLOSURE

In one aspect of the present disclosure, an alignment pin attachable to a first member for piloted engagement with an aperture defining a circular edge portion within a second member is provided. The alignment pin includes a curved tip portion. A piloting section includes a conical locating portion extending circumferentially from the curved tip portion. A cylindrical locating portion extending from the conical locating portion defines a first height and a first diameter. An engagement portion extending from the cylindrical locating portion defines a second height and a second diameter. The second diameter is less than the first diameter of the cylindrical locating portion and a ratio of the second height to the first height is about 2:3. The engagement portion of the alignment pin is structured and arranged to engage within a receiving hole in the first member. The second member is coupled with the first member through piloted engagement between the circular edge portion of the second member and the sequential piloted engagement with the conical locating portion and the cylindrical locating portion of the alignment pin.

In another aspect of the present disclosure, a piloted engagement assembly is provided. The piloted engagement assembly includes a first member having a hole. The piloted engagement assembly further includes a second member having an aperture defined by a circular edge portion in the second member. The piloted engagement assembly further includes an alignment pin coupling the second member to the first member. The alignment pin includes a curved tip portion. A piloting section includes a conical locating portion extending circumferentially from the curved tip portion. A cylindrical locating portion extending from the conical locating portion defines a first height and a first diameter. An engagement portion extending from the cylindrical locating portion defines a second height and a second diameter. The second diameter is less than the first diameter of the cylindrical locating portion and a ratio of the second height to the first height is about 2:3. The engagement portion of the alignment pin is received within the hole of the first member. The alignment pin couples the second member to the first member through piloted engagement between the circular edge portion of the second member and the sequential piloted engagement with the conical locating portion and the cylindrical locating portion of the alignment pin.

Other features and aspects of this disclosure will be apparent from the following description and the accompanying drawings.

### BRIEF DESCRIPTION OF THE DRAWINGS

FIG. 1 is a exploded perspective view of a portion of an exemplary frame assembly, according to one embodiment of the present disclosure;

FIG. 2 is an enlarged view of an encircled portion 2-2 of FIG. 1, according to one embodiment of the present disclosure;

FIG. 3 is a side view of an alignment pin, according to one embodiment of the present disclosure;

FIG. 4 is a sectional view of a piloted engagement assembly with the alignment pin during piloted engagement, according to one embodiment of the present disclosure; and

FIG. 5 is sectional view of the piloted engagement assembly with the alignment pin after the piloted engagement, according to one embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

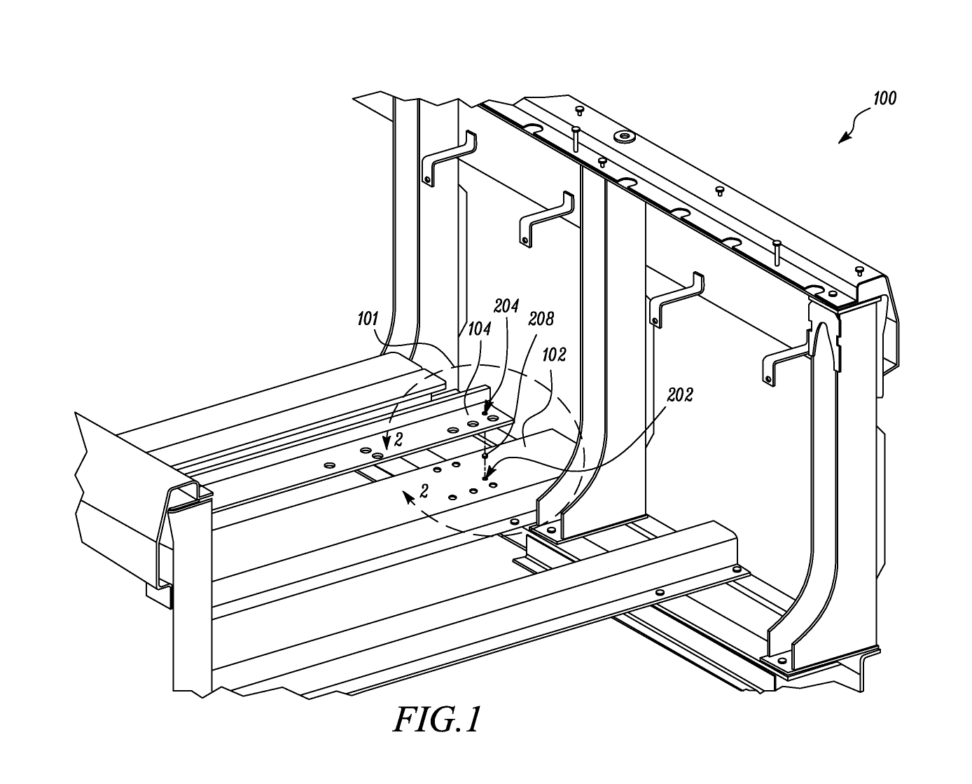

FIG. 1 is an exploded perspective view of a portion of an exemplary frame assembly 100, according to one embodiment of the present disclosure. In an exemplary embodiment, the frame assembly 100 is configured to receive multiple components belonging to an exhaust aftertreatment system (not shown). The components may include an emissions module, a muffler assembly, an SCR (selective catalytic reduction) module etc. Alternatively, the frame assembly 100 may be utilized in connection with any load carriage assembly configured to receive heavy weight components, for example, the frame assembly 100 may be embodied by a portion of an undercarriage assembly for earth moving machines.

A portion of the frame assembly 100 includes a piloted engagement assembly 101. The piloted engagement assembly 101 includes a first member 102 that forms a base of the piloted engagement assembly 101. The piloted engagement assembly 101 also includes a second member 104 configured to be secured to the first member 102 through piloted engagement therewithin. In an example, the second member 104 may be a bottom structure of the emissions module configured to be secured to the first member 102. The first and second members 102, 104 may alternatively include other components and are not limited to that described herein.

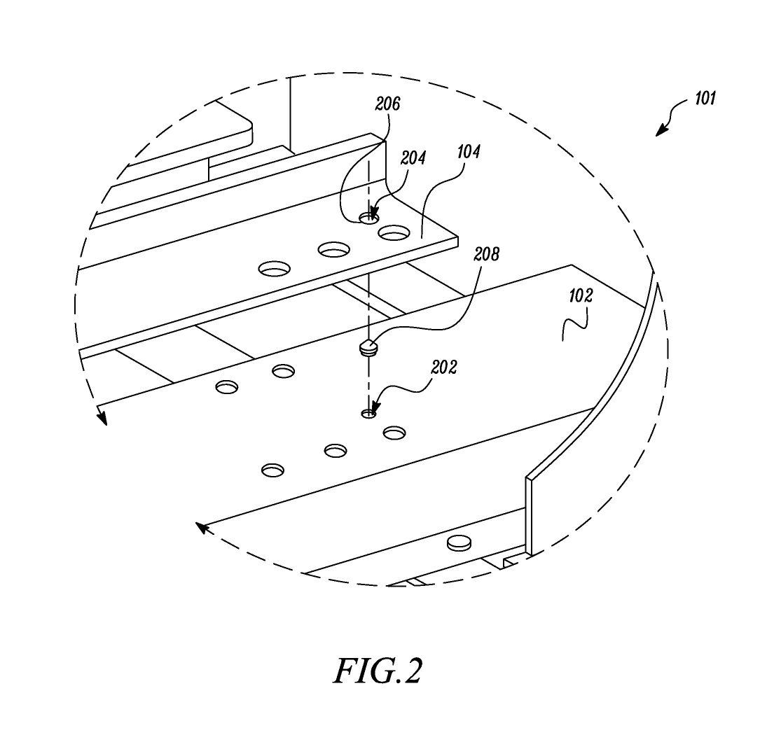

The present disclosure relates to a locator pin or an alignment pin 208 for piloted engagement between the first and second members 102, 104. Accordingly, a hole 202 is provided on the first member 102, and a corresponding aperture 204 is provided on the second member 104 for receiving the alignment pin 208 therethrough. The aperture 204 is defined by a circular edge portion 206 (see FIG. 2) in the second member 104.

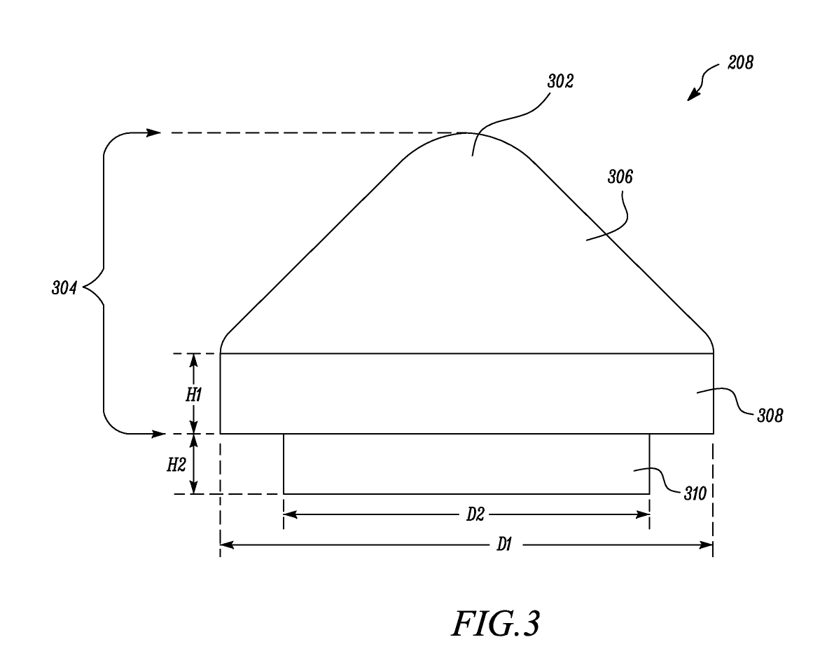

The design and structure of the alignment pin 208 will now be explained in detail with reference to FIG. 3. As shown in FIG. 3, the alignment pin 208 includes a curved tip portion 302. The curved tip portion 302 has a spherical tip. The curved tip portion 302 may be formed, for example by machining. The alignment pin 208 further includes a piloting section 304. The piloting section 304 includes a conical locating portion 306 extending circumferentially from the curved tip portion 302. The piloting section 304 further includes a cylindrical locating portion 308 extending from the conical locating portion 306. The cylindrical locating portion 308 is connected to the conical locating portion 306 via a rounded edge portion. The cylindrical locating portion 308 forms a shoulder of the alignment pin 208. The cylindrical locating portion 308 defines a first height “H1” and a first diameter “D1” of the cylindrical locating portion 308.

The alignment pin 208 further includes an engagement portion 310. The engagement portion 310 extends from the cylindrical locating portion 308. The engagement portion 310 forms a shank of the alignment pin 208. The engagement portion 310 includes a cylindrical configuration. The cylindrical configuration of the engagement portion 310 defines a second height “H2” and a second diameter “D2” of the engagement portion 310. As shown, the second diameter “D2” of the engagement portion 310 is lesser than the first diameter “D1” of the cylindrical locating portion 308. In one embodiment, a ratio of the second height “H2” of the engagement portion 310 to the first height “H1” is approximately 2:3.

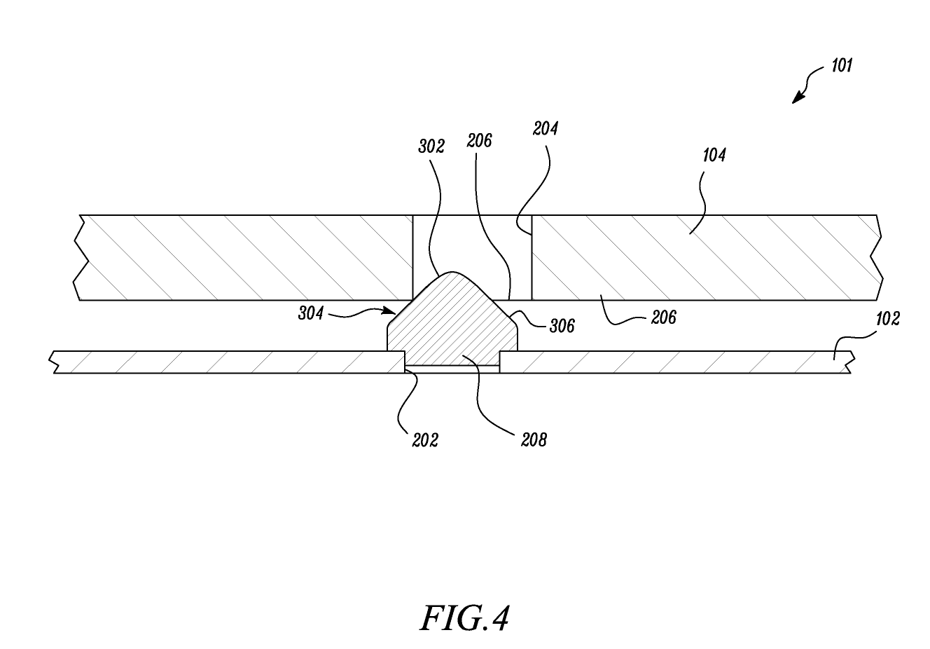

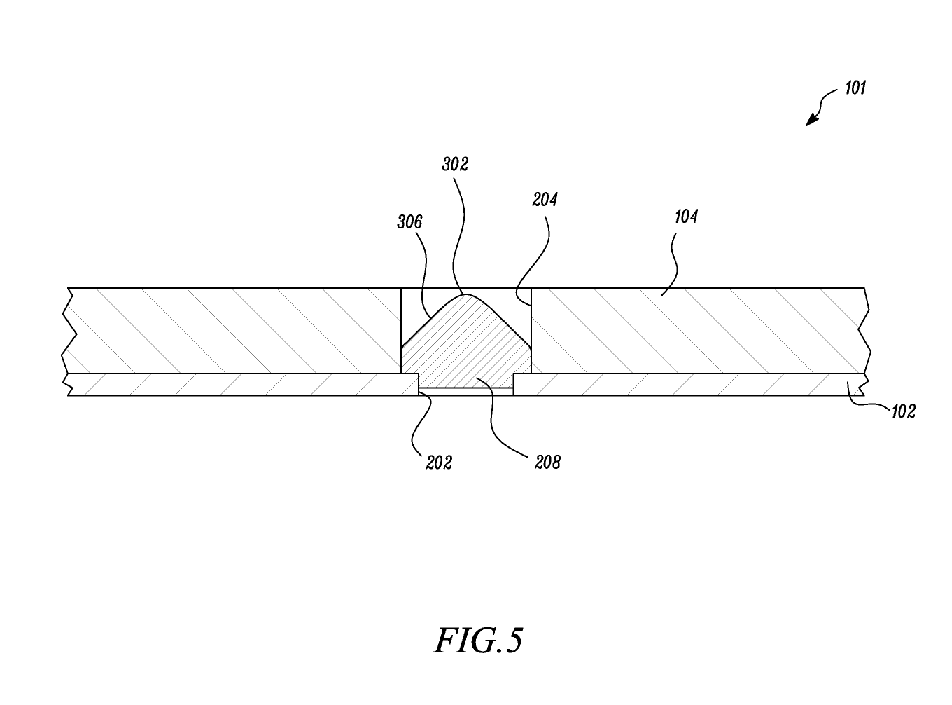

The working of the alignment pin 208 for piloted engagement between the first and second members 102, 104 will now be explained with reference to FIGS. 4 and 5. The structure and arrangement of the engagement portion 310 of the alignment pin 208 is such that the alignment pin 208 is received into the hole 202 of the first member 102. The alignment pin 208 may be dropped into the hole 202 and coupled therein by any known joining means, such as, for example, welding.

The second member 104 may then be lowered onto the alignment pin 208 that is coupled to the first member 102. As shown in FIG. 4, during the lowering of the second member 104, the aperture 204 defining the circular edge portion 206 contacts the curved tip portion 302 or the conical locating portion 306 of the piloting section 304. The piloting section 304 of the alignment pin 208 is structured in such a manner that on contacting the piloting section 304 of the alignment pin 208, the second member 104 slides along the piloting section 304 for sequential piloted engagement therewith.

The piloting section 304 of the alignment pin 208 assists in locating, positioning, and aligning the first member 102 and the second member 104 for piloted engagement through the alignment pin 208. A slant surface of the conical locating portion 306 interacts with the second member 104 such that the aperture 204 of the second member 104 can self-align with the hole 202 of the first member 102. The slant surface of the alignment pin 208 allows lateral movement of the second member 104 with respect to the first member 102, for alignment thereof.

Referring to FIG. 5, the piloted engagement assembly 101 is illustrated showing the second member 104 in a surrounding contacting relationship with the alignment pin 208. The second member 104 is coupled to the first member 102 through piloted engagement between the circular edge portion 206 (see FIG. 4) of the second member 104 and the sequential piloted engagement with the conical locating portion 306 and the cylindrical locating portion 308 of the alignment pin 208. Although, in illustrated embodiment, there is shown no gap between the cylindrical locating portion 308 and the aperture 204, it may be contemplated that a pre-calculated gap is defined therewithin, such that the second member 104 can be easily assembled onto the first member 102 with negligible mis-alignment in the piloted engagement assembly 101.

In an embodiment, there may be two or more such piloted engagement assemblies 101 used to assemble any two components, wherein the first piloted engagement assembly assists in positioning the parts and the second piloted engagement assembly assists in securing the orientation of the components with respect each other.

The alignment pin 208 is a unitary component and can be made of any suitable material based on the application. The dimensions of the alignment pin 208 may be appropriately selected based on the environment of use and is not limited to that described herein. Tight tolerances for interaction between the alignment pin 208 and the hole 202 of the first member 102, and also the aperture 204 of the second member 104 may be appropriately selected to form the desired fit for the piloted engagement.

### INDUSTRIAL APPLICABILITY

The present disclosure describes the alignment pin 208, industrial applicability of which will be readily appreciated from the foregoing discussion. The curved tip portion 302 and the piloting section 304 of the alignment pin 208 allow for the sequential piloted engagement between the first member 102 and the second member 104. Further, the curved tip portion 302, the conical locating portion 306, and the cylindrical locating portion 308 allow smooth transitioning during alignment and positioning of the first member 102 relative to the second member 104.

The alignment pin 208 does not include sharp or pointed edges and tips. The curved tip portion 302 of the alignment pin 208 may minimize or eliminate damage to surrounding components. Further, the alignment pin 208 may minimize or eliminate injury during installation due to the curved design. The alignment pin 208 has universal and varied applicability and can be easily utilized in association with different working environments. Further, the alignment pin 208 aids in installations that are very heavy. The alignment pin 208 may be easily stored in part bins without decreasing usability. Further, the alignment pin 208 provides a low cost, easy to use solution and also increases installation speed.

The piloted engagement achieved through the alignment pin 208 is especially useful in case of heavy assemblies or parts that may otherwise be difficult to align while using a crane for installation. Generally, the crane may help in vertically movement for alignment between the mating components, however, lateral movement may be difficult to achieve due to the heavy weight of the components. In the present disclosure, the slant surface of the alignment pin 208 allows for the lateral movement that is required to appropriately align the mating components, that is the first and second members 102, 104.

The first and second members 102, 104 may additionally or optionally be provided with angled alignment portions (not shown) at one or more corners or along an entire side thereof so as to assist in macro alignment of the system. The alignment pin 208 may then be provided at remaining corners or along the side of the first and second members 102, 104 in order to achieve micro alignment.

The self alignment offered by the alignment pin 208 allows for the alignment pin 208 to be used in environments having space restrictions such that no additional or external tools, for example, metal rods, need to be used for installing the alignment pin 208. An overall height of the alignment pin 208 is relatively less, approximately less than 7 mm, thereby providing a low profile design. The low profile design provides reduced interference with other surrounding components.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An alignment pin attachable to a first member for piloted engagement with an aperture within a second member, the aperture being defined by a circular edge portion in the second member, the alignment pin comprising:
a curved tip portion;
a piloting section comprising:
a conical locating portion extending circumferentially from the curved tip portion; and
a cylindrical locating portion extending from the conical locating portion, the cylindrical locating portion having a cylindrical configuration defining a first height and a first diameter; and
an engagement portion extending from the cylindrical locating portion, the engagement portion having a cylindrical configuration defining a second height and a second diameter, wherein the second diameter is less than the first diameter of the cylindrical locating portion and a ratio of the second height to the first height is about 2:3, wherein the engagement portion of the alignment pin is structured and arranged to engage within a receiving hole in the first member,
wherein the second member is coupled with the first member through piloted engagement between the circular edge portion of the second member and the sequential piloted engagement with the conical locating portion and the cylindrical locating portion of the alignment pin.

2. A piloted engagement assembly comprising:
a first member having a hole;
a second member having an aperture defined by a circular edge portion in the second member; and
an alignment pin coupling the second member to the first member, the alignment pin comprising:
a curved tip portion;
a piloting section comprising:
a conical locating portion extending circumferentially from the curved tip portion; and
a cylindrical locating portion extending from the conical locating portion, the cylindrical locating portion having a cylindrical configuration defining a first height and a first diameter; and
an engagement portion extending from the cylindrical locating portion, the engagement portion having a cylindrical configuration defining a second height and a second diameter, wherein the second diameter is less than the first diameter of the cylindrical locating portion and a ratio of the second height to the first height is about 2:3, wherein the engagement portion of the alignment pin is received within the hole of the first member,
wherein the alignment pin couples the second member to the first member through piloted engagement between the circular edge portion of the second member and the sequential piloted engagement with the conical locating portion and the cylindrical locating portion of the alignment pin.
